(19) United States
(12) Patent Application Publication
(10) Pub. No.: US 2026/0142976 A1
(43) Pub. Date: May 21, 2026

(54) AUTHENTICATION ENABLEMENT IN DESKTOP APPLICATIONS

(71) Applicant: Cisco Technology, Inc., San Jose, CA (US)

(72) Inventors: Harold Todd Chapman, Howell, MI (US); Christina Marie Fosheim-Hoag Keefer, Brighton, MI (US); Jacob Charles Ingman, Saint Paul, MN (US); Linfei Qu, Santa Clara, CA (US); Jordan David Neidlinger, Saline, MI (US)

(21) Appl. No.: 18/951,098

(22) Filed: Nov. 18, 2024

(51) Int. Cl. H04L 9/40

(52) U.S. Cl. CPC H04L 63/0884

(57) ABSTRACT

This disclosure describes techniques for secure, password-less authentication of a user identity. The techniques include receiving a request related to authentication of a user identity in an embedded browser of the user device. The techniques include sending, to an authentication service, an indication that the authentication of the user identity at the embedded browser is incomplete. In response to the incomplete authentication, the techniques include receiving, from the authentication service, an instruction to continue the authentication with a system browser on the user device. Validation of the user identity may be performed with the system browser of the user device. Device information obtained from the validation of the user identity in the system browser may be sent to the authentication service. In response to the device information from the validation, the authentication of the user identity in the embedded browser may be completed.

### TECHNICAL FIELD

The present disclosure relates generally to secure authentication methods for determining a user identity associated with a computing device that is attempting to access a network, thereby improving security of the network.

### BACKGROUND

Authentication refers to proving a user identity so that a user may access a system, organization, or information. The user may provide a credential to the system in order to gain access. The credential may be previously agreed on between the user and the system. The credential may be a password associated with an account of the user or may be a password-less method of proving the user identity. Note that authentication may alternatively or additionally include proving that the computing device from which the access is being requested is associated with the user identity.

In general, password-less authentication is viewed as being more secure than password-based authentication. Passwords may be stolen, guessed, or hacked through credential stuffing. Password-less authentication may use stronger cryptographic methods and may be less susceptible to phishing attacks. Password-less authentication may include the use of biometrics, security keys, and/or mobile apps to provide a secure login experience. In some examples, password-less authentication may be able to reduce administrative overhead in addition to helping enterprises reduce risk. Password-less authentication may also be more convenient for the user, rather than having to remember and manage a large number of increasingly complex passwords. However, although password-less authentication is becoming more common, some legacy applications may be unable to support password-less authentication technologies.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. In some cases, parentheticals are utilized after a reference number to distinguish like elements. Use of the reference number without the associated parenthetical is generic to the element. The systems depicted in the accompanying figures are not to scale and components within the figures may be depicted not to scale with each other.

FIG. 1 illustrates a component diagram with an example environment in which password-less authentication concepts may be employed as part of communications between network devices, in accordance with the present concepts.

FIG. 2 illustrates an example call-flow diagram that may represent communications among network devices, in accordance with the present concepts.

FIGS. 3A-3F illustrate an example authentication scenario that may include information displayed on a user device, in accordance with the present concepts.

FIGS. 4 and 5 illustrate flow diagrams of example methods for the use of password-less authentication concepts as a part of communications among network devices, in accordance with the present concepts.

FIG. 6 illustrates a computing system diagram illustrating a configuration for a data center that can be utilized to implement aspects of the technologies disclosed herein.

FIG. 7 is a computer architecture diagram showing an illustrative computer hardware architecture for implementing a computing device that can be utilized to implement aspects of the various technologies presented herein.

### DESCRIPTION OF EXAMPLE EMBODIMENTS

### Overview

This disclosure describes, at least in part, a method that may be implemented by an authentication agent on a user device communicatively coupled to one or more network devices. The method may include receiving, at the user device and from an authentication service at a remote computing resource, a request related to authentication of a user identity in an embedded browser of the user device. The method may include sending, to the authentication service, an indication that the authentication of the user identity at the embedded browser is incomplete. The method may also include receiving, from the authentication service, an instruction to continue the authentication with a system browser on the user device. The method may include performing a validation of the user identity with the system browser of the user device. The method may include sending, to the authentication service, device information obtained from the validation of the user identity in the system browser. In response to sending the device information from the validation, the method may also include receiving an instruction, from the authentication service, to complete the authentication of the user identity in the embedded browser.

This disclosure also describes, at least in part, another method that may be implemented by authorization service embodied by one or more network devices communicatively coupled to a user device. The method may include receiving, at the authentication service, a request for authentication of a user identity in an embedded browser of the user device. The method may also include receiving, at the authentication service and from an authentication agent, first device information related to the user identity and the embedded browser of the user device. The method may include receiving, at the authentication service, a request for a uniform resource locator (URL) related to the authentication. The method may include sending, by the authentication service, the URL with an instruction to continue the authentication with a system browser on the user device. The method may further include receiving, at the authentication service and from the authentication agent, second device information related to the user identity and a validation process completed at the system browser of the user device. Based at least in part on the first device information and the second device information, the method may include determining that the authentication of the user identity in the embedded browser is successful.

Additionally, the techniques described herein may be performed by a system and/or device having non-transitory computer-readable media storing computer-executable instructions that, when executed by one or more processors, performs the method described above.

### Example Embodiments

This disclosure describes techniques for enabling password-less authentication in applications. Some applications may perform authentication in an embedded browser that does not support password-less authentication. In order to complete password-less authentication within such an embedded browser, the techniques may include using a system browser on the same computing device as the embedded browser to assist with completing the password-less authentication process. The result is a successful, secure authentication within the embedded browser, without the user having entered a password.

In some views, password-less authentication is the future of secure authentication and will replace the use of passwords. A password-less authenticator creates and stores user credentials (e.g., a hardware security key, passkey) on a device (e.g., a user device such as a mobile device, tablet, laptop, or desktop). With password-less authentication, there is no need for a password - a user can authenticate with facial recognition or fingerprint scanning, for instance. Since the user does not enter a password, it is harder for hackers to steal credentials, and the user does not need to memorize or manage multiple passwords. An example of a password-less authenticator is Web Authentication (WebAuthn). WebAuthn is a browser-based application programming interface (API) that is being built into browsers and platforms. WebAuthn enables a user to sign in with a cryptographic key pair, or a passkey. Stated another way, WebAuthn uses public key cryptography to register and authenticate a computing device that is associated with the user. Therefore, WebAuthn allows web applications to simplify user authentication by using registered devices (e.g., phones, laptops, etc.) as factors.

Unfortunately, legacy applications and even some current applications have been slow to adopt these new password-less authentication technologies to allow users to achieve secure authentication without passwords. For example, many legacy applications perform authentications in embedded browsers that do not support WebAuthn. Embedded browsers may refer to a browser embedded in another application, often called a webview. As a result, users may have to authenticate with less secure authentication methods, such as with a password. Because legacy applications may not be able to take advantage of the superior security features of password-less authentication, organizations may ultimately be prevented from leaving password-based authentication behind. The present techniques may be viewed as unlocking modern authentication technologies in applications that do not natively support password-less authentication.

In some implementations, a desktop agent or authentication agent (e.g., Cisco Duo Desktop) may be installed on a user computing device. The desktop agent may have registered cryptographic signing keys with an authentication service (e.g., Cisco Duo). The desktop agent may be able to collect information about a computing device and cryptographically sign a report, proving the identity of the computing device and/or the user submitting the report. By harnessing the ability of Duo Desktop to cryptographically sign health reports, an embedded browser (e.g., webview) can complete a password-less authentication (e.g., WebAuthn) by delegating the authentication to the system browser on the same computing device. Note that the system browser is assumed to support password-less authentication (WebAuthn), and it is also assumed that the user has registered a password-less authentication. If the system browser can complete the password-less authentication and both the system browser and the embedded browser trigger the collection of device health reports that have been cryptographically signed by the same keys, then the authentication service (Duo) may allow the embedded browser to complete an authentication. Although the embedded browser did not perform password-less authentication independently, the scenario carries the assurance that the authentication of the user satisfies all the security properties of password-less authentication.

To summarize, the disclosed techniques enable password-less authentication for applications that do not natively support password-less authentication technologies. In some examples, password-less authentication enablement may be viewed as a relatively lightweight way to improve network security while allowing interaction with legacy applications.

Although the examples described herein may refer to authentication agent on a computing device (e.g., user device), the techniques can generally be applied to any device in a network. For instance, the password-less authentication concepts are generally applicable for any network of devices managed by any entity where data traffic is sent over a network, virtual resources are provisioned, and/or remote services are accessed. In some instances, the techniques may be performed by software-defined networking (SDN), and in other examples, various devices may be used in a system to perform the techniques described herein. The devices by which the techniques are performed herein are a matter of implementation, and the techniques described are not limited to any specific architecture or implementation.

The techniques described herein provide various improvements and efficiencies with respect to network communications. For instance, the techniques described herein may increase the security of data and/or reduce the amount of computational resource use, storage, dropped data, latency, and other issues experienced in networks due to lack of network resources, overuse of network resources, issues with timing of network communications, and/or improper routing of data. By improving network communications across a network, overall performance by and/or security related to servers and virtual resources may be improved.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

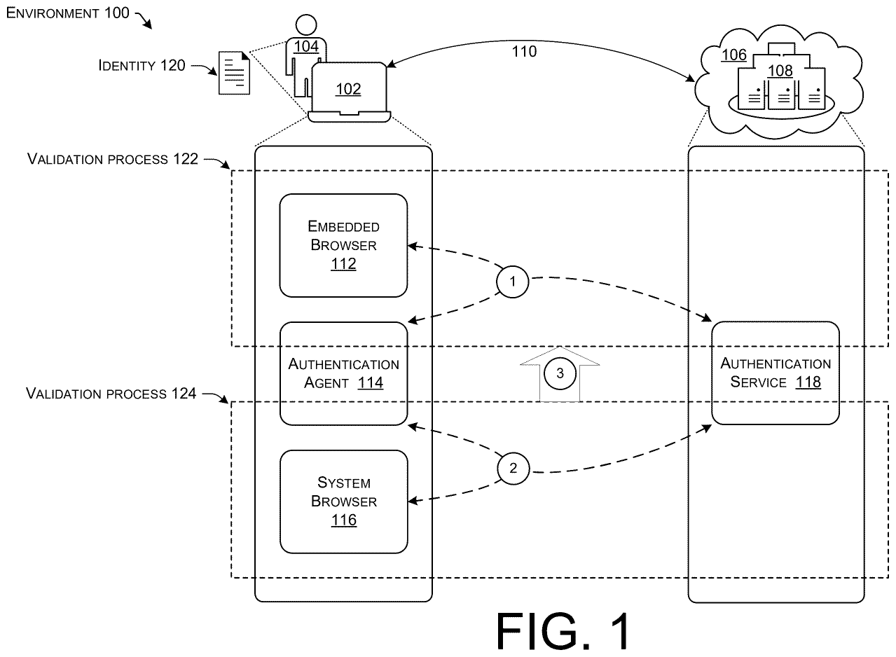

FIG. 1 illustrates an example environment 100 in accordance with the present password-less authentication concepts. Example environment 100 may include a user device 102 and a user 104 associated with the user device 102. Environment 100 may also include a computing network 106, which may include one or more computing devices 108 (e.g., servers, cloud computing resources). The user device 102 may represent any of a variety of user device types, such as a computer, laptop, mobile device, tablet, etc. The computing network 106 may represent a cloud computing network, such as the internet. The use of a cloud computing network in this example is not meant to be limiting. Other types of networks are contemplated in accordance with password-less authentication concepts.

Any of the devices of environment 100 may be communicatively coupled to various other devices of environment 100 via network connection(s), represented by double arrow 110. Within the example environment 100, any of the devices (e.g., user device 102, computing devices 108, etc.) may exchange communications (e.g., packets) via the network connection(s). For instance, the network connections may be transport control protocol (TCP) network connections or any network connection (e.g., information-centric networking (ICN)) that enable the network devices to exchange packets with other devices via the network connections. The network connections represent, for example, data paths between the devices of environment 100. It should be appreciated that the term “network connection” may also be referred to as a “network path.” Note that the exchange of communications between the network devices in environment 100 may include other devices that are not shown, such as routers, gateway devices, etc. In some examples, the network devices may be considered part of a local area network, or a software defined wide area network (SD-WAN).

User device 102 may include several features, capabilities, and/or applications, such as an application that operates with an embedded browser 112, an authentication agent 114 (e.g., desktop agent), and a system browser 116. Environment 100 may also include an authentication service 118 that is provided via the computing network 106, via at least one of the computing devices 108 of computing network 106, for instance. In some implementations, the authentication service 118 may work with the authentication agent 114. For instance, authentication service 118 may be used to assist user 104 of user device 102 to authenticate a user identity 120 associated with the user 104 and/or with the user device 102.

FIG. 1 depicts an example password-less authentication scenario involving embedded browser 112. The password-less authentication scenario may be related to user 104 authenticating user identity 120 using user device 102. In the example shown in FIG. 1, the scenario includes a first validation process 122 and a second validation process 124, which may be viewed as portions of an overall password-less authentication. A dashed-line box represents the entities that may be involved with each validation process. For example, first validation process 122 may involve embedded browser 112, authentication agent 114, and authentication service 118, while validation process 124 may involve authentication agent 114, system browser 116, and authentication service 118.

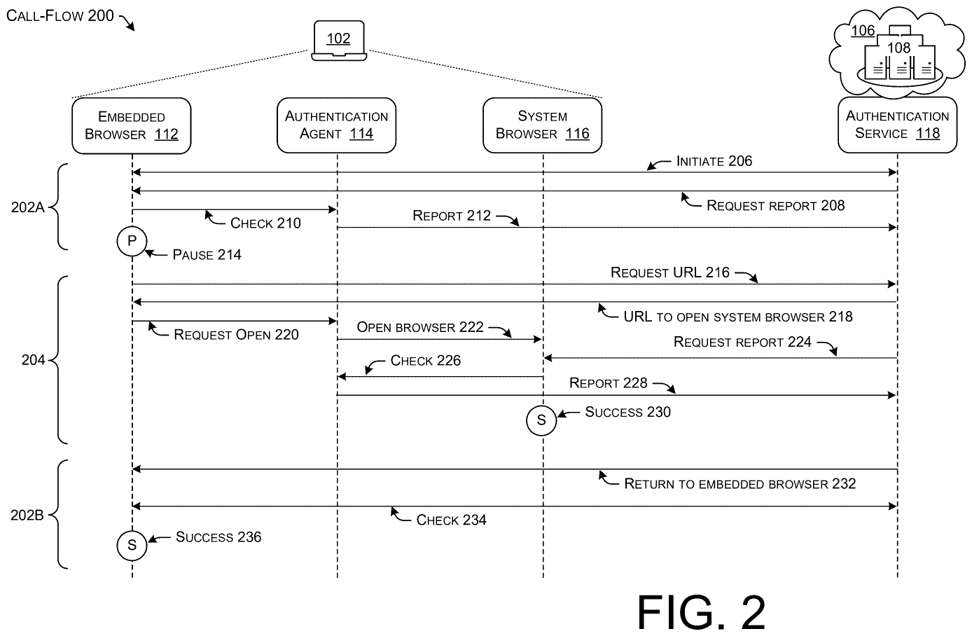

As shown in FIG. 1, the password-less authentication scenario also includes examples of communications between various devices of environment 100. The communications are indicated with dashed, numbered arrows. For example, at “Step 1,” embedded browser 112, authentication agent 114, and authentication service 118 may communicate to initiate first validation process 122 as part of the overall password-less authentication with embedded browser 112. (A more detailed example of potential communications in first validation process 122 will be described below relative to FIG. 2.) However, authentication agent 114 and/or authentication service 118 may determine that embedded browser 112 is not capable of completing a password-less authentication. For instance, embedded browser 112 may be part of an application that does not support password-less authentication methods. Therefore, first validation process 122 may be paused and/or incomplete.

At “Step 2,” authentication agent 114 and authentication service 118 may continue the password-less authentication scenario by working with system browser 116. System browser 116 may be able to complete aspects of a password-less authentication procedure that were not supported by embedded browser 112. Here again, a more detailed example of potential communications that may be part of second validation process 124 will be described below relative to FIG. 2. Note that the suggestion of a system browser for the second step in the password-less authentication scenario is not meant to be limiting. In other examples, another component may be used for validating the user identity, such as another entity or component that is capable of working with passkeys.

At “Step 3,” authentication agent 114 and/or authentication service 118 have successfully completed validation process 124. In this example scenario, by working with system browser 116, authentication agent 114 and authentication service 118 were able to authenticate user identity 120 without user 104 having to enter a password on user device 102. Authentication agent 114 and/or authentication service 118 may then be able to return to first validation process 122. The completion of second validation process 124 may have provided new information or data that enables authentication agent 114 and/or authentication service 118 to complete first validation process 122 with embedded browser 112. As such, the overall password-less authentication may be completed without user 104 having to enter a password on user device 102.

FIG. 2 illustrates an example call-flow 200 in accordance with the present password-less authentication concepts. The example call flow may be representative of communications between the devices of environment 100 described relative to FIG. 1, above. Some aspects of the example elements shown in FIG. 2 may be similar to aspects of the examples described above relative to FIG. 1. Therefore, for sake of brevity, not all elements of FIG. 2 will be described in detail.

The example call-flow 200 includes communications between user device 102 and authentication service 118. Authentication service 118 is provided via at least one of the computing devices 108 of computing network 106. As described above relative to FIG. 1, user device 102 may include several features, such as an application that operates with embedded browser 112, authentication agent 114, and system browser 116. Example call-flow 200 may represent an overall password-less authentication related to authenticating using user device 102, similar to the scenario described above for FIG. 1. Referring to FIG. 2, the scenario may include a first validation process 202 and a second validation process 204. As depicted in FIG. 2, the first validation process 202 may be started, then paused for the second validation process 204 to proceed, then the overall authentication may return to the first validation process 202. As such, FIG. 2 depicts a first validation process portion 202A, followed by second validation process 204, then a first validation process portion 202B. It should also be appreciated that more or fewer communications might be performed than shown in FIG. 2 and described herein. At least some of these communications may also be performed in parallel, or in a different order than those described herein. Some or all of these communications may also be performed by components other than those specifically identified.

Example communications of call-flow 200 will now be described in more detail. As shown in FIG. 2, first validation process portion 202A may be initiated at 206 with a user of user device 102 wishing to securely and easily authenticate in embedded browser 112. Note that in some examples, at some point in the authentication process, or before the authentication process begins, authentication service 118 may check to see that password-less authentication will be possible. For instance, authentication service 118 may check to confirm that a passkey for the user exists before attempting or continuing to try password-less authentication.

At 208, authentication service 118 may request information from user device 102. For example, authentication service 118 may request a device health report related to user device 102. A device health report may help authentication service 118 have confidence that user device 102 is compliant with policies of authentication service 118, and that user device 102 is not compromised with respect to security in some manner. In some examples, the device health report may include information about the user device 102 such as an operating system, a version of the operating system, whether the operating system is up-to-date, whether a browser is up-to-date, whether a firewall is set, WiFi networks to which the device is connected, an ID of the device, etc. In order to ensure that the device health report corresponds to user device 102, the device health report may be cryptographically signed using existing, registered signing keys, for instance. The signing keys may have been created previously or originally by the user authenticating with/registering user device 102 to authentication service 118. The signing keys may include a public key that is held by authentication service 118 and a private key that is kept securely at the user device 102, for instance. In some examples, the private key may be held by authentication agent 114. The signing keys may give authentication agent 114 the ability to sign and send a device health report to authentication service 118 that is not able to be forged or is at least very difficult to forge. Therefore, authentication service 118 can be assured that such a health report came from user device 102.

At 210, embedded browser 112 may try to begin the process of authenticating the user. The embedded browser may proceed by checking with the authentication agent 114. For instance, the embedded browser 112 may ask the authentication agent 114 to send the device health report to the authentication service 118. At 212, the authentication agent may send the device health report to the authentication service 118. The embedded browser 112 may also check for an API related to authentication. However, in this example, embedded browser 112 does not support password-less authentication (e.g., does not support WebAuthn). The API(s) may not be present with embedded browser 112, or an API may be present, but the request for the API may have returned an error. For one or more reasons, embedded browser 112 may determine that password-less authentication is not supported or otherwise will not be possible.

At 214, once embedded browser 112 was not able to complete authentication, first validation process 202 may be paused. At this point, embedded browser 112 may begin second validation process 204 to continue to make progress toward a password-less authentication solution. At 216, embedded browser 112 may request a uniform resource locator (URL) from the authentication service 118 to complete a separate or alternative authentication, second validation process 204, with system browser 116. Alternatively, in some implementations, a user may initiate second validation process 204. For example, the user may be having trouble with password-less authentication into an application and may be able to manually trigger second validation process 204. The trigger may be available through a button, or by clicking a link, for instance. Therefore, second validation process 204 may be viewed as assisted authentication that may be offered automatically or provided upon request from a user.

At 218, authentication service 118 creates a URL for performing a second validation process 204 and returns the URL to embedded browser 112. Authentication service 118 may send the URL with instructions to open a system browser 116 of user device 102 using the URL, for example. At 220, embedded browser 112 may communicate the URL and/or the instructions to open the system browser 116 to the authentication agent 114. At 222, in this example, authentication agent 114 may open the system browser 116 of user device 102 with the URL. Note that the URL may be specific to the user. For example, the URL may correspond specifically to a username of the user, or otherwise to the user identity of the user, so that the URL may not be used by another user.

At 224, authentication in the system browser 116 begins. Authentication service 118 may communicate with the system browser 116 to request information, such as a device health report. Note that step 224 may be viewed as similar to step 208 described above. At 226, system browser 116 may check with authentication agent 114 for the device health report. Here again, a device health report may be cryptographically signed using existing, registered signing keys. Also at 226, system browser 116 may check for an API related to authentication, and/or may complete policy checks. The process of completing the policy checks may be directed by and/or in response to instructions from authentication service 118. Also note: the user of user device 102 may use a third-party passkey provider, in which case system browser 116 may allow the user to access the passkey provider as part of the authentication process. At 228 the information that was requested by authentication service 118 may be provided. For instance, authentication service 118 may receive the device health report corresponding to user device 102, a report confirming completion of second validation process 204, etc. Therefore, at 230, second validation process 204 may be successfully concluded. In other scenarios, there may be instances in which second validation process 204 is unsuccessful. In unsuccessful instances, an option may be provided for the user to return to the embedded browser 112, such as to continue with a password-type login process.

At 232, once second validation process 204 is successfully concluded, authentication service 118 may return to the embedded browser 112 to complete first validation process 202. The return to the embedded browser 112 may be automatic, driven by the authentication service 118, or the return may be caused by the user responding to an indication that the second validation process 204 is complete, for instance. At 234, authentication service 118 may check whether the information gained through second validation process 204 is helpful for completing first validation process 202. For instance, authentication service 118 may compare the cryptographic signature on the device health report gained through second validation process 204 with the cryptographic signature on the device health report from paused first validation process portion 202A. In an instance where the signatures match and/or all policy checks pass, then first validation process portion 202B may be successfully completed and the authentication may be approved. For example, the cryptographic signature(s), a user ID of the user of user device 102, and/or an application ID may be compared to see if these features match as expected for a successful authentication. Note that some checks may be different between the authentication processes in the embedded browser 112 and the system browser 116. For example, one of the checks may include confirming that the browser version is up to date, which may be performed for both the embedded browser 112 and the system browser 116 to ensure that the authentication is valid.

At 236, first validation process portion 202B is successfully completed, and the user may be routed to their application. In this scenario, authentication of the user and/or the user device 102 has succeeded with the same security assurances as if the user of user device 102 had completed password-less authentication (e.g., WebAuthn) in embedded browser 112.

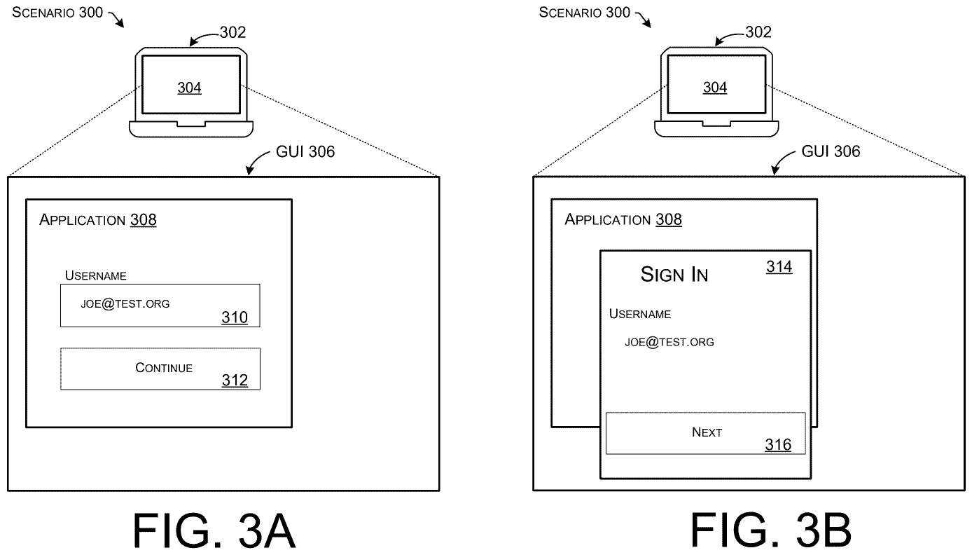

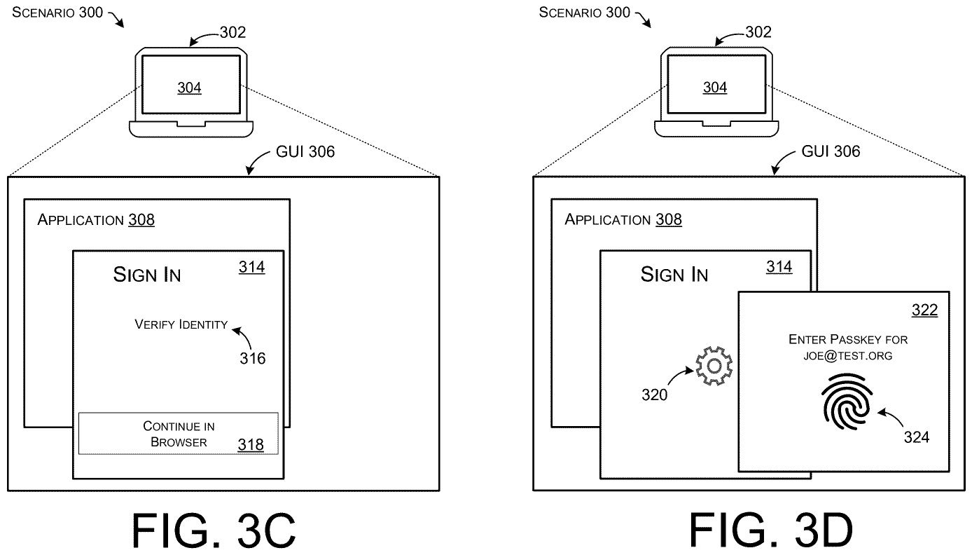

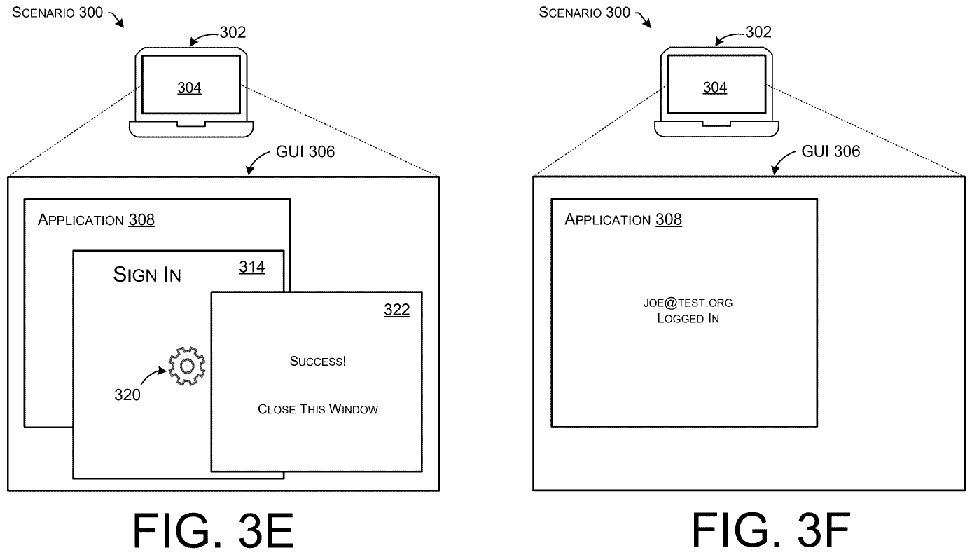

FIGS. 3A-3F illustrate an example password-less authentication scenario 300 in accordance with the present password-less authentication concepts. The example scenario 300 may be representative of information displayed on a user device 302 in response to interaction from a user or to communications with other devices, similar to the communications described relative to FIGS. 1 and 2, above. The example graphics depicted in the accompanying figures are not to scale and a wide variety of designs, sizes, and arrangements of windows, displayed messages, etc., are contemplated. Also, it should also be appreciated that more or fewer graphics, windows, prompts, selectable options, etc., might be provided than shown in FIG. 3 and described herein, or provided in a different order, for instance.

In scenario 300, user device 302 has a display 304, which may show a graphical user interface (GUI) 306. A user may wish to access an application, which may be represented in an application window 308 on GUI 306, for instance. Access to the application may require a login or authentication process. As shown in FIG. 3A, the application window 308 may feature a variety of graphics, such as an entry box 310 in which to enter a username and/or a button 312. The user may enter a username “joe@test.org” in the entry box and may click the button 312 to continue the authentication process.

As shown in FIG. 3B, an embedded browser window 314 may be activated when the user enters the username. In some examples, the application may be configured to work with an authentication service (such as authentication service 118 from FIG. 1). The embedded browser window 314 may be associated specifically with an account (e.g., user identity) related to the username that was entered. The embedded browser window 314 may include a variety of graphics and/or features, such as a button 316 for prompting the process to continue to a next step, which the user may select. In some examples, a user indication to continue with authentication may be similar to step 206 of FIG. 2, the initiation of an authentication process.

As shown in FIG. 3C, the embedded browser window 314 may show an indication (at 316) that password-less authentication is not possible within the embedded browser without further verification of an identity of the user. Embedded browser window 314 may provide a selectable option for the user to continue the authentication process in another browser, by selecting button 318, in this example. In other examples, the user may automatically be taken to the next step in the process, without being offered a selectable option to continue.

FIG. 3D illustrates an instance in which a system browser window 322 has been opened for the authentication process to proceed. In this instance, the embedded browser window 314 may indicate (at 320) that the embedded browser is waiting for further information. Meanwhile, the system browser window 322 may prompt the user for a passkey (at 324). Note that the suggestion of a fingerprint type biometric is not meant to be limiting, any of a variety of types of passkeys are contemplated. Also note that at this point, a third-party passkey provider (e.g., 1Password, Bitwarden) may be accessed. For instance, the system browser window 322 may allow the user to access the passkey provider to complete the passkey.

FIG. 3E, illustrates an instance in which the user has completed a validation process within system browser window 322, and is prompted to close the system browser window 322, in this example. The result of the user completing the validation process within system browser window 322 may be that the overall password-less authentication process is able to finish successfully, and the user may then be logged in to the application, as shown in application window 308 in FIG. 3F. Note that in other examples, system browser window 322 may not display an indication of success of the validation process, and the GUI 306 may automatically change to show that the user is logged in at application window 308.

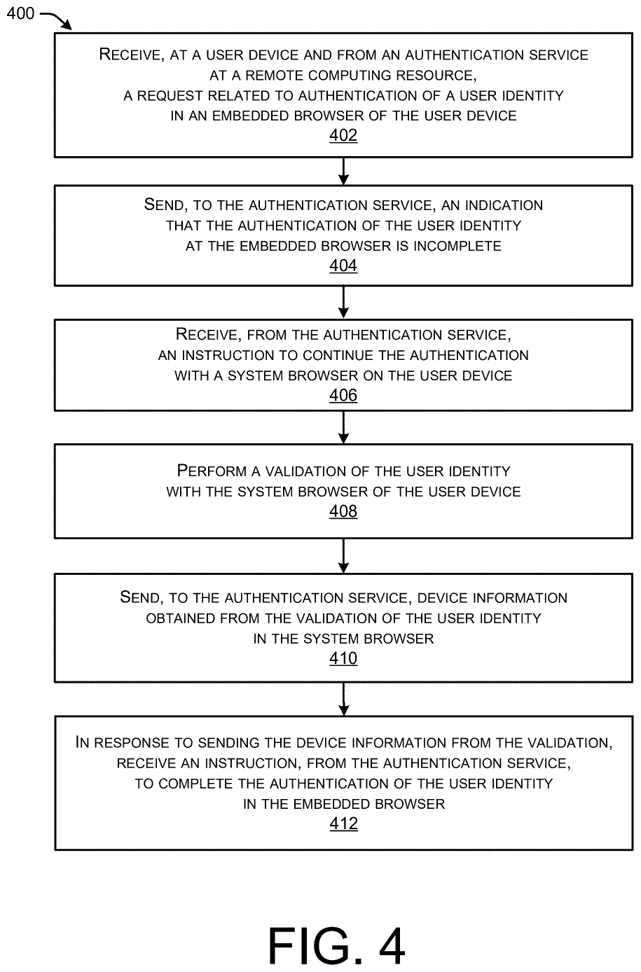

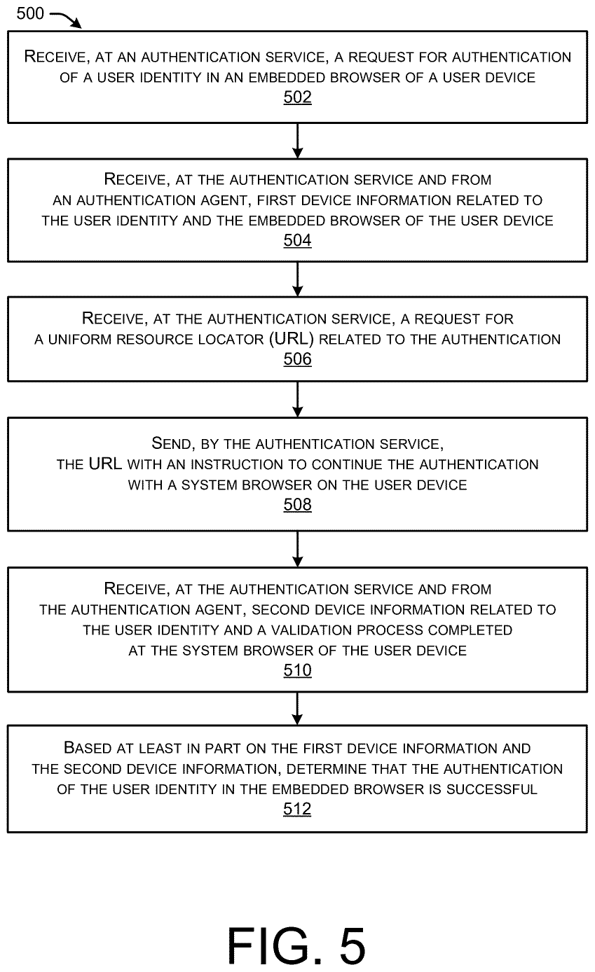

FIGS. 4 and 5 illustrate flow diagrams of example methods 400 and 500 that include functions that may be performed by a computing device, such as user device 102 or at least one of computing devices 108, described relative to FIGS. 1-3F. The logical operations described herein with respect to FIGS. 4 and 5 may be implemented (1) as a sequence of computer-implemented acts or program modules running on a computing system and/or (2) as interconnected machine logic circuits or circuit modules within the computing system. In some examples, the method(s) 400 and/or 500 may be performed by a system comprising one or more processors and one or more non-transitory computer-readable media storing computer-executable instructions that, when executed by the one or more processors, cause the one or more processors to perform the method(s) 400 or 500.

The implementation of the various devices and/or components described herein is a matter of choice dependent on the performance and other requirements of the computing system. Accordingly, the logical operations described herein are referred to variously as operations, structural devices, acts, or modules. These operations, structural devices, acts, and modules may be implemented in software, in firmware, in special purpose digital logic, and any combination thereof. It should also be appreciated that more or fewer operations might be performed than shown in the FIGS. 4 and 5 and described herein. These operations may also be performed in parallel, or in a different order than those described herein. Some or all of these operations may also be performed by components other than those specifically identified. Although the techniques described in this disclosure is with reference to specific devices, in other examples, the techniques may be implemented by less devices, more devices, different devices, or any configuration of devices and/or components.

FIG. 4 illustrates a flow diagram of an example method 400 for an authentication agent to perform password-less authentication techniques. Method 400 may be performed by a user device (e.g., user device 102) communicatively coupled to resources in a computing network (e.g., any of computing devices 108 of computing network 106), for instance.

At 402, method 400 may include receiving a request related to authentication of a user identity in an embedded browser of the user device. The request may be received from an authentication service at a remote computing resource, such as from any of computing devices 108 of computing network 106 described relative to FIG. 1, for instance. In some examples, the request may be a request for device information about the user device and/or information related to the user identity. The device information may refer to, for instance, a device health report. There may also be a request for information about the embedded browser of the user device, such as whether the embedded browser is up-to-date, or whether the embedded browser is able to support a password-less authentication procedure, etc. In some examples, the request may have been triggered by a user attempting to log in to an application using the user device. The application may include a component or feature (e.g., Duo Prompt) that is able to communicate with the authentication service, for instance.

At 404, method 400 may include sending, to the authentication service, an indication that the authentication of the user identity at the embedded browser is incomplete. In some examples, the indication that the authentication is incomplete may include an indication that an application programming interface (API) related to the authentication process was not accessible at the embedded browser, or not present, or otherwise returned an error code when the embedded browser attempted to proceed with the authentication process. The indication sent to the authentication service may relay the error or other information about the pause or delay in authentication.

At 406, method 400 may include receiving, from the authentication service, an instruction to continue the authentication with a system browser on the user device. For instance, method 400 may include receiving, from the authentication service, a uniform resource locator (URL). In some examples, the URL may be sent to an authentication agent on the user device. The authentication agent may then use the URL to open the system browser. The URL may correspond to the user identity. For instance, the URL may be specific to a username or other information directly related to the user identity. In some examples, the embedded browser may request the URL from the authentication service when the authentication process in the embedded browser does not reach satisfactory completion.

At 408, method 400 may include performing a validation of the user identity with the system browser of the user device. The validation of the user identity in the system browser may comprises a password-less validation of the user identity. For instance, the validation may rely on a biometric, a passkey, and/or some other password-less form of ensuring the user identity of the user of the user device.

At 410, method 400 may include sending, to the authentication service, device information obtained from the validation of the user identity in the system browser. In some implementations, the method 400 may include an authentication agent on the user device signing a first device health report related to the portion of the authentication process that involves the embedded browser. Method 400 may also include sending the signed first device health report to the authentication service. Method 400 may also include the authentication agent signing a second device health report related to the validation of the user identity at the embedded browser and sending the second device health report to the authentication service. In some examples, the first device health report and the second device health report may then be used to complete the authentication of the user identity. For instance, the authentication service may compare or match the signatures on the first device health report and the second device health report and/or other information from the user device to determine that the user identity has been sufficiently validated.

At 412, method 400 may include receiving an instruction, from the authentication service, to complete the authentication of the user identity in the embedded browser. In some examples, the instruction may be received in response to sending the device information from the validation to the authorization service.

FIG. 5 illustrates a flow diagram of an example method 500 for network devices to perform password-less authentication techniques. Method 500 may be performed by a network device (e.g., one or more of computing devices 108) communicatively coupled to a user device (e.g., user device 102), for instance.

At 502, method 500 may include receiving, at an authentication service, a request for authentication of a user identity in an embedded browser of the user device. For instance, the authentication service may receive a request initiated by a user to sign on to an application via the user device. The authentication service may view the request as an initiation of an authentication process, to ensure that the user of the user device is allowed to access the application with the user identity.

At 504, method 500 may include receiving, at the authentication service and from an authentication agent, first device information related to the user identity and the embedded browser of the user device. The first device information may comprise a device health report indicating whether the embedded browser is compliant with policies related to the authentication of the user identity.

At 506, method 500 may include receiving, at the authentication service, a request for a uniform resource locator (URL) related to the authentication. The URL may correspond to the user identity. For instance, the URL may be produced specifically for an instance of attempting to validate the user identity on the user device.

At 508, method 500 may include sending, by the authentication service, the URL. The URL may be sent to the embedded browser. The URL may be sent with an instruction to continue the authentication process with a system browser on the user device. The instruction may cause the embedded browser to forward the URL and/or the instruction to the authentication agent. The instruction may cause the authentication agent to open the system browser on the user device. Opening the system browser on the user device may include presenting information to the user regarding the validation process, such as an indication of progress with the validation process, a prompt for the user to be able to continue with the validation process, or a prompt for the user to enter further information to the validation process.

At 510, method 500 may include receiving, at the authentication service and from the authentication agent, second device information related to the user identity and a validation process completed at the system browser of the user device. The validation process may have been completed without the user having to enter a password. The system browser may also send other information regarding the validation process and/or its completion to the authentication service.

At 512, method 500 may include determining that the authentication of the user identity in the embedded browser is successful. The determination of a successful authentication may be based at least in part on the first device information and the second device information. In some examples, the determination of a successful authentication may include matching a first signature of the first device information to a second signature of the second device information, wherein the first signature and the second signature are signed by the authentication agent of the user device. The authentication service may further compare the signatures by the authentication agent to public keys held by the authentication service to complete the authentication process.

Following the successful authentication, the user may be able to access the application on the user device with the user identity. As such, the user was able to sign on to the application in the embedded browser on the user device without having to enter a password.

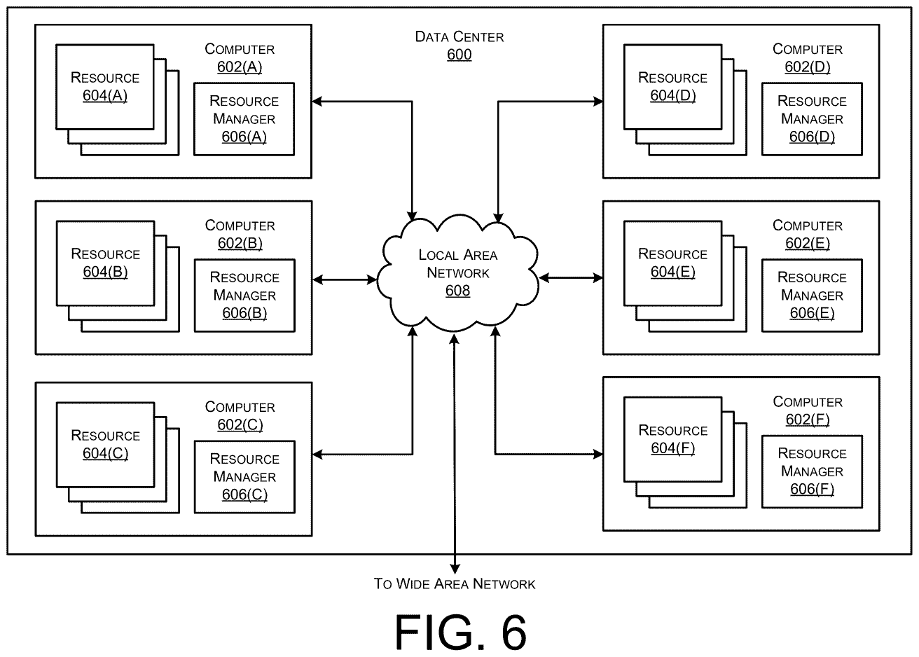

FIG. 6 is a computing system diagram illustrating a configuration for a data center 600 that can be utilized to implement aspects of the technologies disclosed herein. The example data center 600 shown in FIG. 6 includes several computers 602A-602F (which might be referred to herein singularly as “a computer 602” or in the plural as “the computers 602”) for providing computing resources. In some examples, the resources and/or computers 602 may include, or correspond to, any type of networked device described herein, such as any of computing devices 108. Although, computers 602 may comprise any type of networked device, such as servers, switches, routers, hubs, bridges, gateways, modems, repeaters, access points, hosts, etc.

The computers 602 can be standard tower, rack-mount, or blade server computers configured appropriately for providing computing resources. In some examples, the computers 602 may provide computing resources 604 including data processing resources such as virtual machine (VM) instances or hardware computing systems, database clusters, computing clusters, storage clusters, data storage resources, database resources, networking resources, and others. Some of the computers 602 can also be configured to execute a resource manager 606 capable of instantiating and/or managing the computing resources. In the case of VM instances, for example, the resource manager 606 can be a hypervisor or another type of program configured to enable the execution of multiple VM instances on a single computer 602. Computers 602 in the data center 600 can also be configured to provide network services and other types of services.

In the example data center 600 shown in FIG. 6, an appropriate local area network (LAN) 608 is also utilized to interconnect the computers 602A-602F. It should be appreciated that the configuration and network topology described herein has been greatly simplified and that many more computing systems, software components, networks, and networking devices can be utilized to interconnect the various computing systems disclosed herein and to provide the functionality described above. Appropriate load balancing devices or other types of network infrastructure components can also be utilized for balancing a load between data centers 600, between each of the computers 602A-602F in each data center 600, and, potentially, between computing resources in each of the computers 602. It should be appreciated that the configuration of the data center 600 described with reference to FIG. 6 is merely illustrative and that other implementations can be utilized.

In some examples, the computers 602 may each execute one or more application containers and/or virtual machines to perform techniques described herein. For instance, the containers and/or virtual machines may serve as server devices, user devices, and/or routers in the computing network 106.

In some instances, the data center 600 may provide computing resources, like application containers, VM instances, and storage, on a permanent or an as-needed basis. Among other types of functionality, the computing resources provided by a cloud computing network may be utilized to implement the various services and techniques described above. The computing resources 604 provided by the cloud computing network can include various types of computing resources, such as data processing resources like application containers and VM instances, data storage resources, networking resources, data communication resources, network services, and the like.

Each type of computing resource 604 provided by the cloud computing network can be general-purpose or can be available in a number of specific configurations. For example, data processing resources can be available as physical computers or VM instances in a number of different configurations. The VM instances can be configured to execute applications, including web servers, application servers, media servers, database servers, some or all of the network services described above, and/or other types of programs. Data storage resources can include file storage devices, block storage devices, and the like. The cloud computing network can also be configured to provide other types of computing resources 604 not mentioned specifically herein.

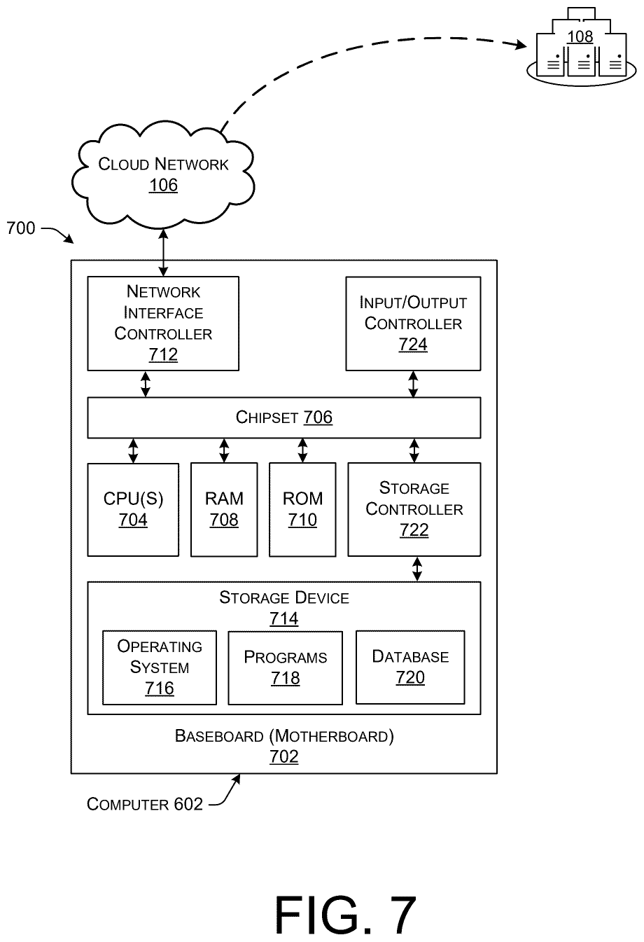

The computing resources 604 provided by a cloud computing network may be enabled in one embodiment by one or more data centers 600 (which might be referred to herein singularly as “a data center 600” or in the plural as “the data centers 600”). The data centers 600 are facilities utilized to house and operate computer systems and associated components. The data centers 600 typically include redundant and backup power, communications, cooling, and security systems. The data centers 600 can also be located in geographically disparate locations. One illustrative embodiment for a data center 600 that can be utilized to implement the technologies disclosed herein will be described below with regards to FIG. 7.

FIG. 7 shows an example computer architecture 700 for a computer 602 capable of executing program components for implementing the functionality described above. The computer architecture 700 shown in FIG. 7 illustrates a conventional server computer, workstation, desktop computer, laptop, tablet, network appliance, e-reader, smartphone, and/or other computing device, and can be utilized to execute any of the software components presented herein. The computer 602 may, in some examples, correspond to a physical device described herein (e.g., user device, network device, controller device, server device, etc.), and may comprise networked devices such as servers, switches, routers, hubs, bridges, gateways, modems, repeaters, access points, etc. For instance, computer 602 may correspond to user device 102.

As shown in FIG. 7, the computer 602 includes a baseboard 702, or “motherboard,” which is a printed circuit board to which a multitude of components or devices can be connected by way of a system bus or other electrical communication paths. In one illustrative configuration, one or more central processing units (“CPUs”) 704 operate in conjunction with a chipset 706. The CPUs 704 can be standard programmable processors that perform arithmetic and logical operations necessary for the operation of the computer 602.

The CPUs 704 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 706 provides an interface between the CPUs 704 and the remainder of the components and devices on the baseboard 702. The chipset 706 can provide an interface to a RAM 708, used as the main memory in the computer 602. The chipset 706 can further provide an interface to a computer-readable storage medium such as a read-only memory (“ROM”) 710 or non-volatile RAM (“NVRAM”) for storing basic routines that help to start up the computer 602 and to transfer information between the various components and devices. The ROM 710 or NVRAM can also store other software components necessary for the operation of the computer 602 in accordance with the configurations described herein.

The computer 602 can operate in a networked environment using logical connections to remote computing devices and computer systems through a network, such as computing network 106 or network 608, etc. The chipset 706 can include functionality for providing network connectivity through a network interface controller (NIC) 712, such as a gigabit Ethernet adapter. The NIC 712 is capable of connecting the computer 602 to other computing devices over the computing network 106. For instance, in the example shown in FIG. 7, NIC 712 may help facilitate transfer of data, packets, and/or communications over the computing network 106 with one or more of computing devices 108. It should be appreciated that multiple NICs 712 can be present in the computer 602, connecting the computer to other types of networks and remote computer systems.

The computer 602 can be connected to a storage device 714 that provides non-volatile storage for the computer. The storage device 714 can store an operating system 716, programs 718, authentication agent 114, and/or other data. The storage device 714 can be connected to the computer 602 through a storage controller 722 connected to the chipset 706, for example. The storage device 714 can consist of one or more physical storage units. The storage controller 722 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 602 can store data on the storage device 714 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 714 is characterized as primary or secondary storage, and the like.

For example, the computer 602 can store information to the storage device 714 by issuing instructions through the storage controller 722 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 602 can further read information from the storage device 714 by detecting the physical states or characteristics of one or more particular locations within the physical storage units.

In addition to the mass storage device 714 described above, the computer 602 can have access to other computer-readable storage media to store and retrieve information, such as policies, device health reports, APIs, user identities, usernames, passkeys, public or private keys, signatures, program modules, data structures, and/or other data. It should be appreciated by those skilled in the art that computer-readable storage media is any available media that provides for the non-transitory storage of data and that can be accessed by the computer 602. In some examples, the operations performed by the computing network 106, and/or any components included therein, may be supported by one or more devices similar to computer 602. Stated otherwise, some or all of the operations performed by the computing network 106, and or any components included therein, may be performed by one or more computer devices 602 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, ternary content addressable memory (TCAM), and/or other optical storage, magnetic cassettes, magnetic tape, magnetic disk storage or other magnetic storage devices, or any other medium that can be used to store the desired information in a non-transitory fashion.

As mentioned briefly above, the storage device 714 can store an operating system 716 utilized to control the operation of the computer 602. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 714 can store other system or application programs and data utilized by the computer 602.

In one embodiment, the storage device 714 or other computer-readable storage media is encoded with computer-executable instructions which, when loaded into the computer 602, transform the computer from a general-purpose computing system into a special-purpose computer capable of implementing the embodiments described herein. These computer-executable instructions transform the computer 602 by specifying how the CPUs 704 transition between states, as described above. According to one embodiment, the computer 602 has access to computer-readable storage media storing computer-executable instructions which, when executed by the computer 602, perform the various processes described above with regards to FIGS. 1-3F. The computer 602 can also include computer-readable storage media having instructions stored thereupon for performing any of the other computer-implemented operations described herein.

The computer 602 can also include one or more input/output controllers 724 for receiving and processing input from a number of input devices, such as a keyboard, a mouse, a touchpad, a touch screen, an electronic stylus, or other type of input device. Similarly, an input/output controller 724 can provide output to a display (e.g., display 304), such as a computer monitor, a flat-panel display, a digital projector, a printer, or other type of output device. It will be appreciated that the computer 602 might not include all of the components shown in FIG. 7, can include other components that are not explicitly shown in FIG. 7, or might utilize an architecture completely different than that shown in FIG. 7.

As described herein, the computer 602 may comprise one or more devices, such as user device 102, computing devices 108, and/or other devices. The computer 602 may include one or more hardware processors 704 (processors) configured to execute one or more stored instructions. The processor(s) 704 may comprise one or more cores. Further, the computer 602 may include one or more network interfaces configured to provide communications between the computer 602 and other devices, such as the communications described herein as being performed by a computing device 108, user device 102, routers, control plane devices, and/or other devices. In some examples, the communications may include data, packet, instructions, policy, and/or other information transfer, for instance. The network interfaces may include devices configured to couple to personal area networks (PANs), wired and wireless local area networks (LANs), wired and wireless wide area networks (WANs), and so forth. For example, the network interfaces may include devices compatible with Ethernet, Wi-Fi™, and so forth.

The programs 718 may comprise any type of programs or processes to perform the techniques described in this disclosure in accordance with password-less authentication techniques. For instance, the programs 718 may cause the computer 602 to perform techniques for communicating with other devices using any type of protocol or standard usable for determining connectivity. Additionally, the programs 718 may comprise instructions that cause the computer 602 to perform the specific techniques for password-less authentication.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative of some embodiments that fall within the scope of the claims of the application.

What is claimed is:

1. A computer-implemented method comprising:
receiving, at a user device and from an authentication service at a remote computing resource, a request related to authentication of a user identity in an embedded browser of the user device;
sending, to the authentication service, an indication that the authentication of the user identity at the embedded browser is incomplete;
receiving, from the authentication service, an instruction to continue the authentication with a system browser on the user device;
performing a validation of the user identity with the system browser of the user device;
sending, to the authentication service, device information obtained from the validation of the user identity in the system browser; and
in response to sending the device information from the validation, receiving an instruction, from the authentication service, to complete the authentication of the user identity in the embedded browser.

2. The computer-implemented method of claim 1, further comprising:
receiving, from the authentication service, a uniform resource locator (URL); and
using the URL to open the system browser.

3. The computer-implemented method of claim 2, wherein the URL corresponds to the user identity.

4. The computer-implemented method of claim 1, wherein the request related to the authentication of the user identity comprises a request for a device health report of the user device.

5. The computer-implemented method of claim 1, wherein the indication that the authentication of the user identity at the embedded browser is incomplete comprises an indication that an application programming interface (API) related to the authentication was not accessible at the embedded browser.

6. The computer-implemented method of claim 1, further comprising:
signing, by an authentication agent on the user device, a first device health report related to the authentication of the user identity at the embedded browser; and
sending, by the authentication agent, the first device health report to the authentication service, wherein the first device health report is used to complete the authentication of the user identity.

7. The computer-implemented method of claim 6, further comprising:
signing, by the authentication agent, a second device health report related to the validation of the user identity at the embedded browser; and
sending, by the authentication agent, the second device health report to the authentication service, wherein the second device health report is used to complete the authentication of the user identity.

8. The computer-implemented method of claim 1, wherein the validation of the user identity in the system browser comprises a password-less validation of the user identity.

9. A controller device comprising:
one or more processors; and
one or more non-transitory computer-readable media storing computer-executable instructions that, when executed by the one or more processors, cause the one or more processors to:
receive, at a user device and from an authentication service at a remote computing resource, a request related to authentication of a user identity in an embedded browser of the user device;
send, to the authentication service, an indication that the authentication of the user identity at the embedded browser is incomplete;
receive, from the authentication service, an instruction to continue the authentication with a system browser on the user device;
perform a validation of the user identity with the system browser of the user device;
send, to the authentication service, device information obtained from the validation of the user identity in the system browser; and
in response to sending the device information from the validation, receive an instruction, from the authentication service, to complete the authentication of the user identity in the embedded browser.

10. The controller device of claim 9, wherein the computer-executable instructions further cause the one or more processors to:
receive, from the authentication service, a uniform resource locator (URL); and
use the URL to open the system browser.

11. The controller device of claim 10, wherein the URL corresponds to the user identity.

12. The controller device of claim 9, wherein the request related to the authentication of the user identity comprises a request for a device health report of the user device.

13. The controller device of claim 9, wherein the indication that the authentication of the user identity at the embedded browser is incomplete comprises an indication that an application programming interface (API) related to the authentication was not accessible at the embedded browser.

14. The controller device of claim 9, wherein the computer-executable instructions further cause the one or more processors to:
sign, by an authentication agent on the user device, a first device health report related to the authentication of the user identity at the embedded browser; and
send, by the authentication agent, the first device health report to the authentication service, wherein the first device health report is used to complete the authentication of the user identity.

15. The controller device of claim 14, wherein the computer-executable instructions further cause the one or more processors to:
sign, by the authentication agent, a second device health report related to the validation of the user identity at the embedded browser; and
send, by the authentication agent, the second device health report to the authentication service, wherein the second device health report is used to complete the authentication of the user identity.

16. The controller device of claim 9, wherein the validation of the user identity in the system browser comprises a password-less validation of the user identity.

17. A method comprising:
receiving, at an authentication service, a request for authentication of a user identity in an embedded browser of a user device;
receiving, at the authentication service and from an authentication agent, first device information related to the user identity and the embedded browser of the user device;
receiving, at the authentication service, a request for a uniform resource locator (URL) related to the authentication;
sending, by the authentication service, the URL with an instruction to continue the authentication with a system browser on the user device;
receiving, at the authentication service and from the authentication agent, second device information related to the user identity and a validation process completed at the system browser of the user device; and
based at least in part on the first device information and the second device information, determining that the authentication of the user identity in the embedded browser is successful.

18. The method of claim 17, wherein determining that the authentication of the user identity in the embedded browser is successful further comprises:
matching a first signature of the first device information to a second signature of the second device information, wherein the first signature and the second signature are signed by the authentication agent of the user device.

19. The method of claim 17, wherein the URL corresponds to the user identity.

20. The method of claim 17, wherein the first device information comprises a device health report indicating whether the embedded browser is compliant with policies related to the authentication of the user identity.
